(19) United States
(12) Patent Application Publication
(10) Pub. No.: US 2016/0146593 A1
(43) Pub. Date: May 26, 2016

(54) PHOTO-BASED 3D-SURFACE INSPECTION SYSTEM

(71) Applicant: SIEMENS AKTIENGESELLSCHAFT, München (DE)

(72) Inventors: Frank FORSTER, Munich (DE); Tristan SCZEPUREK, Berlin (DE)

(73) Assignee: SIEMENS AKTIENGESELLSCHAFT, Munich (DE)

(21) Appl. No.: 14/899,258

(22) PCT Filed: Mar. 4, 2014
(86) PCT No.: PCT/EP2014/054170

§ 371 Date: Dec. 17, 2015

(30) Foreign Application Priority Data
Jun. 18, 2013 (DE) 10 2013 211 342.0

(51) Int. Cl. G01B 11/00; G06K 9/20; H04N 13/02

(52) U.S. Cl. CPC G01B 11/002; H04N 13/0282; G06K 9/2063

(57) ABSTRACT

At least one carrier is applied onto an object, the at least one carrier including two optically different markings that are spatially separated on the carrier. At least one camera images the object from different spatial directions and a computer executes a program to evaluate images acquired by the at least one camera. Three-dimensional surface measurement of the object is provided by positioning the object onto a central region of a base, applying the carrier onto the object, and acquiring a plurality of images of the object from the different spatial directions.

### CROSS REFERENCE TO RELATED APPLICATIONS

This application is based on and hereby claims priority to International Application No. PCT/EP2014/054170 filed on Mar. 4, 2014 and German Application No. 10 2013 211 342.0 filed on Jun. 18, 2013; the contents of both are hereby incorporated by reference.

### BACKGROUND

In the case of high-quality components, or in general products such as turbine blades, great expectation is placed on the visual and technical condition. In particular, great expectation is placed on the condition of the surface of the component. Because of these high requirements, all distinctive features, for example indentations, must be detected and documented.

Furthermore, for components, or in general for objects, it is necessary to determine their actual three-dimensional geometry and compare this with a setpoint geometry. In this case, the comparison of the actual geometry may, for example, be carried out with computer-aided design (CAD) data of a CAD model. Besides the overall actual geometry, complexly shaped objects usually have characteristic features, for example bores. These must be checked for quality assurance. This may give rise to the additional difficulty that these characteristic features are not visible. For example, the direction of a bore which is scarcely visible from the outside must be checked.

According to the related art, the visual inspection of the object is usually carried out manually. Furthermore, the documentation is enhanced by of the use of images which show various subregions of the object surface. The size and precise position of the recognized distinctive features usually can no longer subsequently be reproduced in this case. Furthermore, the evaluation is often subjective. According to the related art, therefore, camera-based inspection systems are also used for the evaluation. These systems acquire individual images from a plurality of spatial directions or perspectives of the object, but without allowing a full three-dimensional representation of the object.

According to the related art, a comparison between the setpoint and actual geometries is carried out by photogrammetric systems or 3D scanners. In the aforementioned systems, however, generally only the three-dimensional geometry of the object is acquired, but not the surface condition of the object. According to the related art, bores are measured by mechanical measuring probes with a thin needle or interferometric methods. These, however, are expensive and time-consuming.

### SUMMARY

Various embodiments described herein relate to an arrangement for three-dimensional surface measurement of an object, which acquires the full three-dimensional geometry and surface condition of an object with characteristic surface features, in particular with bores.

Various embodiments described herein relate to an arrangement for three-dimensional surface measurement of an object including at least one camera for imaging the object from different spatial directions and a computer having a program, in particular a CAD program, for evaluating the images acquired by the camera. The arrangement further includes at least one carrier having two optically different markings, in particular a red and a green color marking, which are applied to two different positions of the carrier. The optical difference between the markings may be achieved by a different geometrical shape and/or by a different color of the markings.

By virtue of the optically different configuration of the markings, the individual markings can be separated well on the acquired images. The carrier may be applied on a surface of the object. The two optically different markings spatially separated on the carrier advantageously define a line of intersection, or a uniquely determined direction, on the acquired images. Arrangement or application of the carrier on characteristic positions of the object surface, in particular on or in bores, is particularly advantageous.

A method for three-dimensional surface measurement of objects, in particular with an arrangement according to the various embodiments described herein, includes at least once positioning an object to be measured onto a central region of a base, applying a carrier onto the object to be measured, the carrier having at least two optically different markings, and acquiring a multiplicity of images of the object with at least one camera from different spatial directions.

The object to be measured is advantageously positioned on an essentially monochromatic central region of the base. Furthermore, at least one carrier, which bears two optically different markings at different positions, is applied onto the object to be measured. Application on and/or in bores and/or characteristic positions of the object surface, for which accurate angle determination is intended to be made possible, is advantageous.

Subsequently, a multiplicity of images of the object, or of the object surface, are acquired with at least one camera from different spatial directions. The acquisition may be carried out with precisely one camera, which is arranged so that it can be displaced around the object, or by a multiplicity of spatially fixed cameras. Images are therefore acquired for all characteristic regions on the surface, in particular for bores. Imaging of the same object with a different spatial direction allows subsequent three-dimensional reconstruction of the object. It is particularly advantageous that the acquired images contain the information about the condition of the surface of the object. If, for example, the carrier is applied on and/or in a bore and can be seen on at least two images from different directions, then the position of the carrier and therefore the position of the bore can also be determined.

The carrier of the markings may be configured with a needle shape. In this way, the carrier can be introduced, for example, into bores. The direction dictated by the needle shape in this case coincides substantially with the direction of the bore. Also expedient as a carrier is a screw, which can advantageously be screwed into bores which have a screw thread.

According to various embodiments described herein, the optical markings of the carrier are colored markings and have a different color. Because of the different colors, the markings can be discriminated well on colored images. For example, different patterning of the optical markings, which may be colored and/or black/white, also leads to sufficient separability of the markings.

According to various embodiments described herein, the optical markings may be configured with a ball shape. An advantage of a ball-shaped configuration is that they always have the same full circular shape for each imaging direction on the acquired two-dimensional images. The balls are therefore highly suitable for computer-assisted evaluation. In particular, a ball painted red and a ball painted green are advantageous since the two colors green and red can be optically separated particularly well. For example, the balls may be fitted on the end of a needle-shaped carrier, or a needle.

According to various embodiments described herein, the arrangement may have a monochromatic base in a central subregion. A base which has, in the central subregion, a color which essentially does not occur on the surface of the object to be measured is advantageous. In this way, the object to be measured, which expediently lies in the central colored region on the base, can be distinguished unambiguously from the base and from the optical markings. Furthermore, a color which essentially does not correspond to any color of the optical markings is advantageous for the central subregion of the base. In the case of a red colored marking and a green colored marking, and in the case of an essentially gray-colored object, a blue monochromatic central subregion thus proves particularly advantageous.

According to various embodiments described herein, an edge of the base includes optical position markings, in particular circular position markings. The optical position markings are advantageous for calculation of the three-dimensional coordinates or the three-dimensional position of the at least one camera. Furthermore, the position markings allow freely adjustable positioning of the at least one camera, since the three-dimensional position of the camera can be determined by the optical markings acquired on the images. In this way, the object to be measured can be positioned with an essentially arbitrary orientation on the central subregion of the base.

According to various embodiments described herein, a spatial position of at least one camera relative to the base may be calculated by using optical position markings. This is made possible by optical position markings on an edge of the base. In this case, the three-dimensional position of the at least one camera is calculated for each acquired image.

According to various embodiments described herein, automated detection or separation of the object to be measured and the base may be carried out by a computer. In this case, it is advantageous for the base to be monochromatic in a central subregion and, in particular, to have a color which essentially does not correspond to any color on the object surface. In this way, automated separation of the object and the base can be significantly improved. Furthermore, the object contour can be detected by the separation.

According to various embodiments described herein, the spatial position of the object to be measured may be calculated by a computer. In this way, the position of the object, in particular the position of characteristic surface features, for example bores, can be acquired three-dimensionally. In this case, it is expedient to use coordinates which correspond to the coordinates used in a CAD program (CAD coordinate system). In this way, the measured coordinates, i.e. the spatial position of the object, can be compared to the coordinates in the CAD program. Furthermore, the three-dimensional coordinates of the camera may be calculated for each image.

According to various embodiments described herein, the acquired images of the surface may be transferred, in particular as texturing, onto a surface of a CAD model of the object, which is contained in the CAD program. This is made possible by determining all relevant three-dimensional coordinates. This leads to a three-dimensional representation of the object to be measured, in particular of the object surface, with the actual texture. This allows quantitative comparison of the actual texture of the object surface with the setpoint texture. Expediently, properties of the exterior geometry, for example outlines, may be employed for the comparison. If it is not possible, at a position of the object surface, to bring the object contours and/or object textures measured and expected according to the CAD model into correspondence, then at this position there is an error of the geometry and/or of the surface of the object.

Various embodiments described herein provide for at least two images of the carrier to be acquired from two different spatial directions. In this way, three-dimensional determination of the position of the carrier is made possible.

According to various embodiments described herein, the optically different and spatially separated markings on the carrier are detected in an automated fashion by a computer.

According to various embodiments described herein, a line of intersection may be calculated from the markings detected in an automated fashion. In this case, there are advantageously two markings on the carrier, or on the acquired images, since a line of intersection is uniquely defined by two spatially separated points. A further line of intersection is obtained by acquiring a second image of the same markings from a new spatial direction. By stereometry, i.e. by the intersection of the two lines of intersection determined, the three-dimensional position of the carrier can be determined according to the coordinates of a CAD coordinate system.

### BRIEF DESCRIPTION OF THE DRAWINGS

These and other objects and advantages will become more apparent and more readily appreciated from the following description of the various embodiments, taken in conjunction with the accompanying drawings of which:

FIG. 1 is a perspective view of a three-dimensional arrangement for two-dimensional surface measurement of an object,

FIG. 2 is a perspective view of a three-dimensional representation of the carrier with two color markings, and

FIG. 3 is a flowchart for the determination of an angle of a bore.

### DETAILED DESCRIPTION OF THE PREFERRED EMBODIMENTS

Reference will now be made in detail to the various embodiments, examples of which are illustrated in the accompanying drawings, wherein like reference numerals refer to like elements throughout.

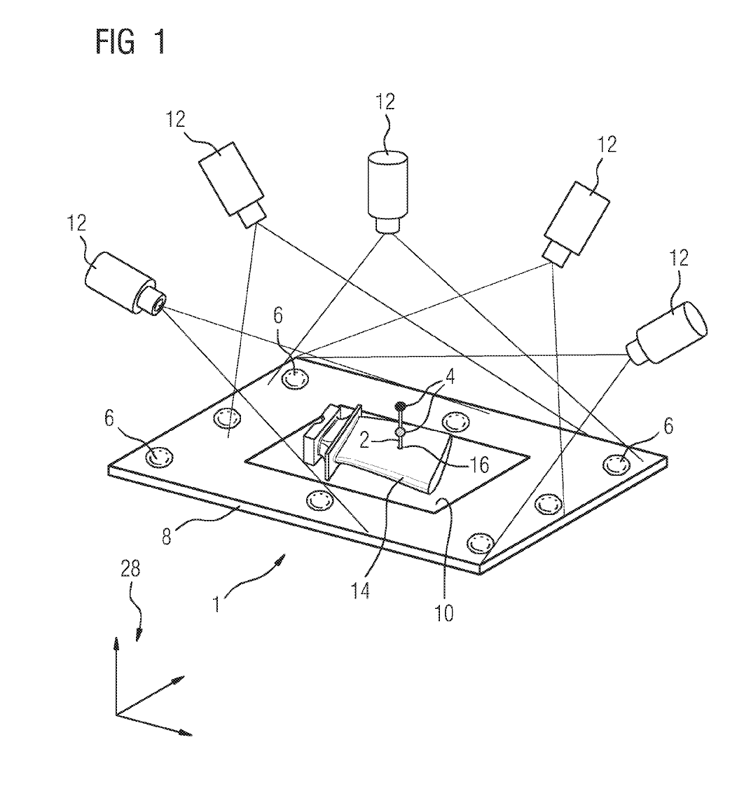

FIG. 1 shows a three-dimensional representation of the arrangement 1 for measuring an object 14, which lies on a central subregion 10 of a base 8. Furthermore, there are optical position markings 6 on the edge of the base 8. FIG. 1 furthermore shows a bore 16 and a carrier 2, in particular a needle-shaped carrier 2, which has two differently colored color markings 4.

The carrier is in this case applied inside a bore 16, the angle 26 of which (not shown in FIG. 1) is intended to be determined in relation to a CAD coordinate system 28. In this case, the carrier 2 may be a needle and/or screw, which is introduced into the bore 16.

The determination, or calculation, of the three-dimensional position of the object 14, and/or of the carrier 2, is made possible by a multiplicity of cameras 12, which acquire images from different spatial directions of the object 14 to be measured. If the images are linked or related to one another in a computer (not represented here), then the three-dimensional position of the object 14 and/or of the carrier 2 can be calculated. Subsequently, for example, an actual model of the object 14 may be constructed in a CAD program. By comparison of the actual model with a setpoint model, which is likewise contained as a model in the CAD program, it is possible to detect errors, in particular errors of the surface of the object 14 and/or incorrect positioning of bores 16.

In this embodiment, five cameras 12 and correspondingly five different spatial directions are represented. Embodiments having more and/or fewer cameras 12 are also possible. For example, even with only one camera 12, which is arranged so that it can be displaced around the object 14, the images can be obtained from different spatial directions. In this case, the displaceability may be implemented electronically, as for example in the case of a 3D manual scanner.

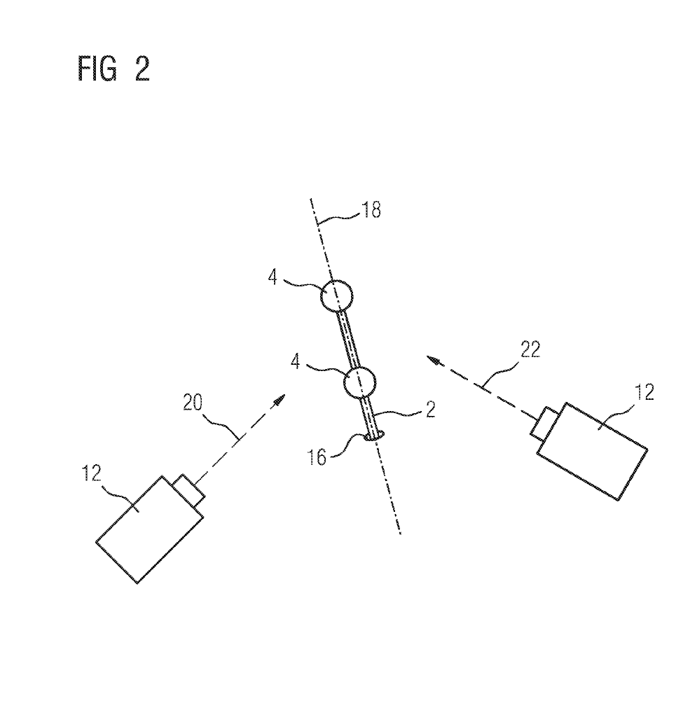

FIG. 2 shows an enlarged representation of the carrier 2, which is introduced into the bore 16. FIG. 2 furthermore shows two cameras 12, which acquire a colored image of the carrier 2 and the color markings 4 from the different spatial directions. For each of the two images, it is possible to calculate a line of intersection 18, which is determined uniquely by the color markings 4. In this case, the color markings 4 have a different color. In this embodiment, the carrier 2 is needle-shaped and the color markings 4 are colored balls.

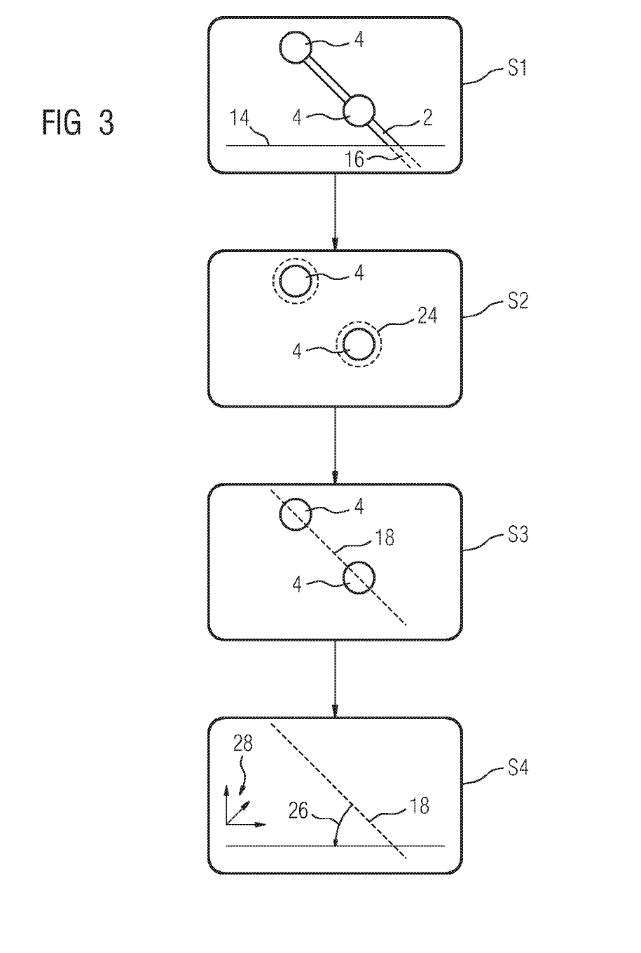

FIG. 3 shows a flowchart of a method for determining an angle 26 at which the bore 16 enters the object 14.

In S1, the carrier 2 with the color markings 4 is introduced into the bore 16, which lies in the object 14.

In S2, the color markings 4 of the carrier 2 on the images are detected by an automated detection 24, in particular by computer-assisted detection.

In S3, a uniquely determined line of intersection 18, which extends through the centers of the detected color markings, is calculated. In particular, a multiplicity of lines of intersection may be calculated for each image from different spatial directions. This may be carried out by of a computer.

In S4, with reference to a CAD coordinate system 28, an angle 26 which corresponds to the angle of the bore 16 is determined by using the calculated lines of intersection 18. In this way, the angle 26 or the actual entry angle 26 of the bore 16 into the object 14 is determined. This allows a comparison of the actual entry angle 26 with the setpoint entry angle of the bore 16.

The various embodiments have been described in detail with particular reference and examples, but it will be understood that variations and modifications can be effected within the spirit and scope of the various embodiments covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-14. (canceled)

15. A system for three-dimensional surface measurement of an object, the system comprising:
at least one carrier applied onto the object, the at least one carrier including two optically different markings that are spatially separated on the carrier;
at least one camera imaging the object from different spatial directions; and
a computer executing a program to evaluate images acquired by the at least one camera.

16. The system as claimed in claim 15, wherein the carrier is needle-shaped.

17. The system as claimed in claim 15, wherein the markings are differently colored markings.

18. The system as claimed in claim 15, wherein the markings are ball-shaped.

19. The system as claimed in claim 15, further comprising a base including a monochromatic subregion onto which the object is positioned.

20. The system as claimed in claim 19, wherein at least one edge of the base includes at least one optical position marking.

21. A method for three-dimensional surface measurement of an object, the method comprising:
positioning the object onto a central region of a base;
applying a carrier onto the object, the carrier including at least two optically different markings;
acquiring, using at least one camera, images of the object from different spatial directions.

22. The method as claimed in claim 21, further comprising calculating a spatial position of the at least one camera relative to the base based on optical position markings included on the base.

23. The method as claimed in claim 22, wherein the calculating the spatial position is executed by a computer.

24. The method as claimed in claim 21, further comprising executing at least one of automated detection of the at least two optically different markings and separation of the object and the base by a computer.

25. The method as claimed in claim 21, further comprising transferring the acquired images onto a surface of a computer-aided design model of the object, the computer-aided design model being contained in a computer-aided design program.

26. The method as claimed in claim 21, wherein the acquiring includes at least two images of the carrier from two different spatial directions.

27. The method as claimed in claim 21, further comprising automated detecting of the at least two optically different markings by a computer.

28. The method as claimed in claim 21, further comprising calculating a line of intersection defined by the at least two optically different markings.
